(19) United States
(12) Patent Application Publication
(10) Pub. No.: US 2026/0359555 A1
(43) Pub. Date: Nov. 12, 2026

(54) INFORMATION PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Bo LI, Beijing (CN); Jiayi ZHANG, Beijing (CN); Man GONG, Beijing (CN); Lu WANG, Beijing (CN); Weilun GUO, Beijing (CN); Zhendong JIANG, Beijing (CN)

(21) Appl. No.: 19/125,717

(22) PCT Filed: Sep. 21, 2023
(86) PCT No.: PCT/CN2023/120324

§ 371 Date: Apr. 29, 2025

(30) Foreign Application Priority Data
Oct. 31, 2022 (CN) 202211351887.X

(51) Int. Cl. G06F 40/177; G06F 16/22; H04L 51/046

(52) U.S. Cl. CPC G06F 40/177; G06F 16/2282; H04L 51/046

(57) ABSTRACT

Provided are an information processing method and apparatus, and an electronic device and a storage medium. The method comprises: displaying an online database table, wherein the online database table comprises at least one preset task field; receiving task data which is input by a user in the online database table and which corresponds to the task field; and in response to a first preset operation of the user in the online database table, creating task information in a task application on the basis of the task data, which is input by the user.

### CROSS-REFERENCE TO RELATED APPLICATIONS

The present application is based on and claims the priority to the Chinese application No. 202211351887.X filed on Oct. 31, 2022, the disclosure of which is incorporated herein by reference in its entirety.

### TECHNICAL FIELD

The present disclosure relates to the field of computer technology, and specifically, to an information processing method and apparatus, and an electronic device and a storage medium.

### BACKGROUND

In task-oriented team collaboration, tasks must be created, distributed, managed, updated, maintained, and the like in time.

### SUMMARY

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

In a first aspect, according to one or more embodiments of the present disclosure, there is provided an information processing method, comprising:
displaying an online database table, the online database table comprising at least one preset task field;
receiving task data corresponding to the task field, which is input by a user in the online database table; and
in response to a first preset operation of the user in the online database table, creating task information in a task application on the basis of the task data input by the user.

In a second aspect, according to one or more embodiments of the present disclosure, there is provided an information processing apparatus, comprising:
a display unit configured to display an online database table, the online database table comprising at least one preset task field;
a receiving unit configured to receive task data corresponding to the task field, which is input by a user in the online database table; and
a creation unit configured to, in response to a first preset operation of the user in the online database table, create task information in a task application on the basis of the task data input by the user.

In a third aspect, according to one or more embodiments of the present disclosure, there is provided an electronic device, comprising: at least one memory and at least one processor, wherein the memory is configured to store program code, and the processor is configured to call the program code stored by the memory so that the electronic device performs the information processing method according to one or more embodiments of the present disclosure.

In a fourth aspect, according to one or more embodiments of the present disclosure, there is provided a non-transitory computer storage medium having thereon stored program code which, when executed by a computer device, causes the computer device to perform the information processing method according to one or more embodiments of the present disclosure.

In a fifth aspect, the present disclosure provides a computer program product which, when executed by a processor, implements the information processing method according to any of the above embodiments.

### BRIEF DESCRIPTION OF THE DRAWINGS

The above and other features, advantages, and aspects of the embodiments of the present disclosure will become more apparent in conjunction with the accompanying drawings and with reference to the following DETAILED DESCRIPTION. Throughout the drawings, the same or similar reference numbers refer to the same or similar elements. It should be understood that the drawings are schematic and that components and elements are not necessarily drawn to scale.

FIG. 1 is a flow diagram of an information processing method according to an embodiment of the present disclosure;

FIGS. 2-5 are schematic diagrams of online database tables according to an embodiment of the present disclosure;

FIG. 6 is a schematic interface diagram of an IM (Instant Message) client according to an embodiment of the present disclosure;

FIG. 7 is a schematic structural diagram of an information processing apparatus according to an embodiment of the present disclosure;

FIG. 8 is a schematic structural diagram of an electronic device according to an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, which are provided for a more complete and thorough understanding of the present disclosure rather. It should be understood that the drawings and the embodiments of the present disclosure are for exemplary purposes only and are not intended to limit the scope of protection of the present disclosure.

It should be understood that steps recited in method embodiments of the present disclosure may be performed in a different order, and/or performed in parallel. Furthermore, the method embodiments may include additional steps and/or omit performing the illustrated steps. The scope of the present disclosure is not limited in this respect.

The term “include” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. The term “in response to” and related terms refer to one signal or event being affected by another signal or event to some extent, but not necessarily completely or directly affected. If an event x occurs “in response to” an event y, x may respond directly or indirectly to y. For example, occurrence of y may ultimately result in occurrence of x, but there may be another intermediate event and/or condition. In another case, y may not necessarily result in occurrence of x, and x may still occur even if y has not yet occurred. Furthermore, the term “in response to” may also mean “at least partially in response to”.

The term “determine” broadly encompasses a wide variety of actions that can include acquiring, calculating, computing, processing, deriving, investigating, searching (e.g., searching in a table, a database or another data structure), ascertaining and the like, and can also include receiving (e.g., receiving information), accessing (e.g., accessing data in a memory) and the like, as well as analyzing, choosing, selecting, establishing and the like. Related definitions for other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that the modification of “a” or “a plurality” mentioned in the present disclosure is intended to be illustrative rather than restrictive, and that those skilled in the art should appreciate that it should be understood as “one or more” unless otherwise explicitly stated in the context.

For the purpose of this disclosure, the phrase “A and/or B” means (A), (B), or (A and B).

In the task management solution provided in the related art, there is a problem of task processing inefficiency.

The names of messages or information exchanged between a plurality of devices in the embodiments of the present disclosure are for illustrative purposes only, and are not intended to limit the scope of these messages or information.

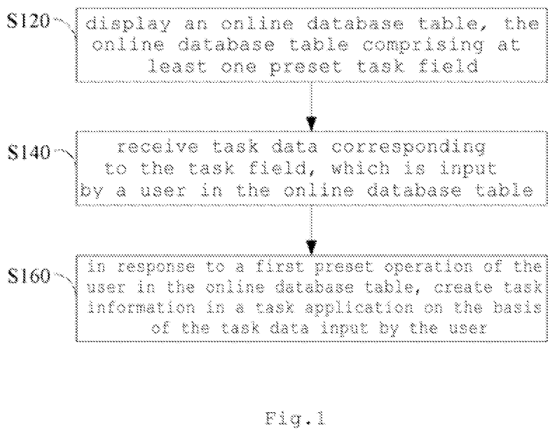

Referring to FIG. 1, FIG. 1 illustrates a flow diagram of an information processing method 100 according to an embodiment of the present disclosure, which comprises steps S120 to S160.

Step S120: displaying an online database table, the online database table comprising at least one preset task field.

In some embodiments, the online database table may be a table document for online editing by a user, multi-user collaboration, and real-time storage in a cloud, which may be displayed by, for example, a hyper text markup language (HTML) page, and in which content edited by the user is synchronized relying on communication between a client and a server. Different from a regular excel or spreadsheet, each column of data in the database table is configured with one data type, and only data corresponding to the data type can be input into cells of the column; and each cell, when created, is assigned a data type, which corresponds to a field of a header row of each column of cell data.

In some embodiments, an execution subject of the method 100 may be a client, for example, an IM (Instant Message) client, which is integrated with the function of the online database table; on the basis of a click operation of the user, the client loads a page of the online database table by calling a browser kernel through an interface provided by a browser, and on the basis of the loaded page, the user may create and edit the online database table, and of course, the user may share the online database table through the client; in other embodiments, the client is therein integrated with a browser kernel, and a page of the online database table is displayed in the client by calling the browser kernel; in other embodiments, the client is an online database table client, and the page of the online database table is loaded and displayed by running the online database table client; and in other embodiments, there is an applet corresponding to the online database table function, and the client loads and displays the page of the online database table by downloading and running source code of the online database table applet.

In some embodiments, the at least one preset task field comprises one or more of: a field for indicating a task title, a field for indicating a task ID, a field for indicating task content, a field for indicating a task-associated person, a field for indicating task time information, a field for indicating a task reminder manner, a field for indicating creating, cancelling or updating a task, a field for indicating a task completion state, and a field for indicating a task synchronization state.

The task-associated person includes but is not limited to a creator, executor, follower, supervisor, etc. of the task; the task time information includes, but is not limited to, a creation time of the task, a deadline of the task; the task reminder manner includes, but is not limited to, a reminder time, a reminder period, or a reminder rule of the task; the task state includes, but is not limited to, a state of the task having not been completed, a state of the task having already been completed; and the task synchronization state is used for reflecting whether the task has been successfully created, whether the task has been already synchronized to the task-associated person, or whether the task is synchronized to a preset task server.

Step S140: receiving task data corresponding to the task field, which is input by a user in the online database table.

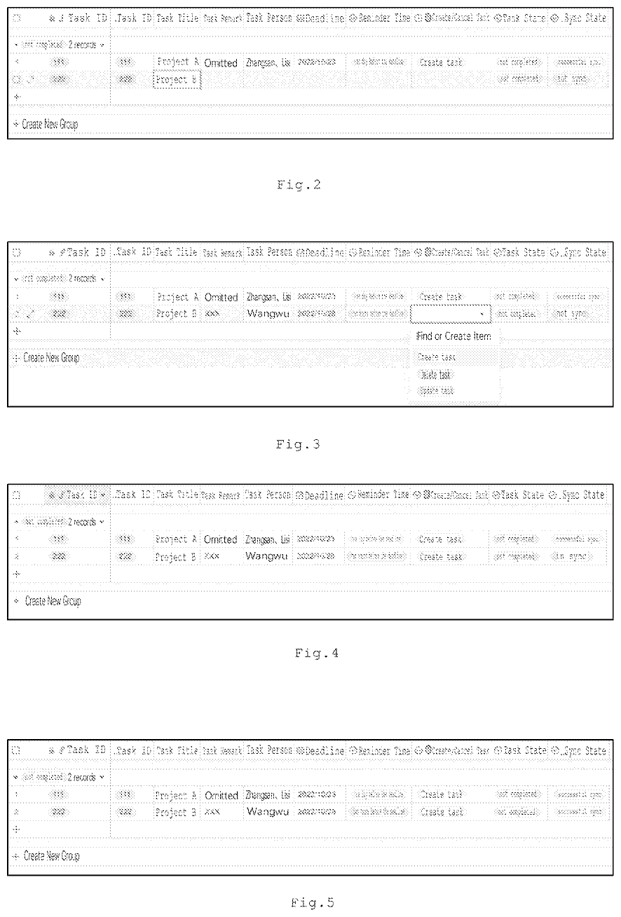

In some embodiments, the online database table may be an online table, and the task field may be a field of the online table, under which the user may fill in corresponding data. Exemplarily, referring to FIG. 2, in cells in a first row of an online database table, a plurality of task fields are sequentially provided, for example, including task fields “Task ID”, “Task Title”, “Task Remark”, “Task Person”, “Deadline”, “Reminder Time”, “Create/Cancel Task”, “Task State”, “Synchronization State”, and the like, and a user may input corresponding data under each task field as corresponding task data, for example, referring to FIG. 2, the user is currently inputting task data “Project B” in a second row under the “Task Title” field as a title of the task to be created.

It should be noted that, it is also possible to, by combining the teaching of the foregoing embodiments and specific practical needs, add another preset task field in the online database table or divide the existing task field in a finer granularity, which is not repeated in the present disclosure. For example, it is possible to add a “Task Attachment” field, a “Task Creation Time” field, and a “Task Link” field, and further divide the “Task Person” into “Task Executor” or “Task follower”, etc.

In some embodiments, the user may also add a new task field or delete an existing task field in the online database table.

Step S160: in response to a first preset operation of the user in the online database table, creating task information in a task application on the basis of the task data input by the user.

The task application may be an application for providing, to the user, services such as creation, distribution, and management (e.g., update, deletion, etc.) of the task information, and may be integrated in the client or server. In some embodiments, the task application may be integrated in an IM client, where the user may create, distribute, and manage the task.

After the user has input the task data corresponding to all or some of the task fields, a new task can be created on the basis of the input task data by a preset operation. The first preset operation includes, but is not limited to, a somatosensory control operation, a gesture control operation, an eyeball shaking operation, a touch control operation, a voice control instruction, or an operation on an external control device.

In some embodiments, the first preset operation of the user in the online database table comprises inputting, by the user, preset first data under a first preset task field in the online database table. Exemplarily, referring to FIG. 3, the user may input “Create task” under a first preset task field “Create/Cancel Task”, so that the task application creates a new task on the basis of the task data input by the user.

In one specific implementation, referring to FIG. 3, one or more options (e.g., “Create task”, “Delete task”, “Update task”) may also be provided under the preset field “Create/Cancel Task” for selection by the user without manual input by the user. For example, the option “Create task” is used for triggering a function of creating a new task on the basis of the task data input by the user; the option “Delete task” is used for triggering a function of deleting an existing task corresponding to a record (e.g., row or column) where it is located; and the option “Update task” is used for triggering a function of updating an existing task on the basis of a current record.

In some embodiments, after the user performs the preset operation on the online database table, the client may send each item of task data input by the user to the server for creating corresponding task information by the server.

In this way, according to one or more embodiments of the present disclosure, by displaying an online database table, the online database table comprising at least one preset task field, receiving task data corresponding to the task field, which is input by a user in the online database table, and in response to a first preset operation of the user in the online database table, creating task information in a task application on the basis of the task data input by the user, the user is enabled to create a task using the online database table, and the user is facilitated to sort, summarize, and subsequently manage the already created task using the online database table.

In some embodiments, the method 100 further comprises:
step S171: determining a task-associated person on the basis of the task data; and
step S172: sending, to the task-associated person, the task information and/or reminder information of the task information.

The task-associated person may include, but is not limited to, a task creator, task executor, task follower, task supervisor, and the like.

Exemplarily, the task-associated person may be determined on the basis of user information (e.g., a user name, user nickname, or user identification, etc.) the user filled in under the task field “Task Person”; the created task information or reminder information thereof can be sent to the task-associated person in a manner such as an IM message, short message, email, and system notification. Referring to FIG. 5, if task data of the task “Project B” under the “Task Person” field is “Wang Wu”, it may be determined that the task-associated person includes a user “Wang Wu”, and task information and/or task reminder information may be sent to the user “Wang Wu”.

In some embodiments, display content of the reminder information comprises one or more of: title information, task subject information, task person information, or task time information. The title information may be generated on the basis of a preset format, for example, the title information may be “User XX assigns you as the task-associated person” or “You are listed as the task-associated person”.

According to one or more embodiments of the present disclosure, by determining the task-associated person on the basis of the task data, and sending the task information and/or the reminder information of the task information to the task-associated person, the task-associated person is facilitated to know the created task in time after the task is created, so as to improve the efficiency in task notification and processing.

In some embodiments, the task information and/or the reminder information of the task information may be sent to the task-associated person and/or the user by an IM (Instant Message) application associated with the online database table.

In some embodiments, the task information and/or the reminder information of the task information may be sent in a form of an IM message by a message robot (bot) provided in the IM application, so that the user can receive the task information and/or the reminder information thereof in time through the IM message automatically sent by the message bot.

In some embodiments, the method 100 further comprises:
step S180: in response to a second preset operation of a recipient of the reminder information for the reminder information, displaying task detail information.

In this embodiment, in response to a second preset operation of a recipient of the reminder information for the reminder information, task detail information is displayed, which can facilitate the recipient to know the task details quickly.

In some embodiments, step S190 comprises:
step S181: in response to a first operation of the recipient for the reminder information, displaying a first page, wherein the first page is used for presenting task information corresponding to the reminder information; and/or
step S182: in response to a second operation of the recipient for the reminder information, displaying a second page, wherein the second page is used for presenting task information associated with the recipient.

In this embodiment, the second page may be a preset task set page, which may include information of all tasks in which the recipient participates, while the first page may be a page specially used for displaying task information corresponding to the reminder information.

In some embodiments, the first and second operations include, but are not limited to, a somatosensory control operation, a gesture control operation, an eyeball shaking operation, a touch control operation, a voice control instruction, or an operation on an external control device.

In a specific implementation, the reminder information may include a first control and a second control, wherein the first control is used for displaying the first page after triggered by the user (for example, after selected by the user), and the second control is used for displaying the second page after triggered by the user (for example, after selected by the user), but this disclosure is not limited thereto.

In some embodiments, the method 100 further comprises:
step S183: in response to an editing operation of the recipient on the task information in the first page and/or the second page, updating the task information.

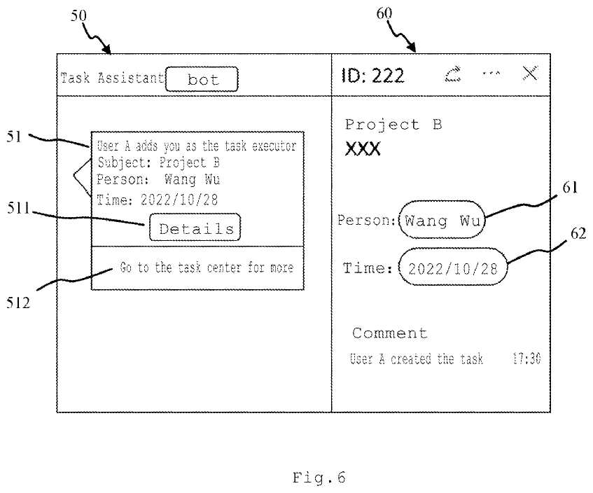

FIG. 6 illustrates that the reminder information of the task information is sent to the task-associated person in a form of an IM message. Referring to FIG. 6, a session interface 50 of the IM application has thereon displayed an IM message 51 as reminder information of the task “Project B”, in which title information “User A adds you as the task executor”, task subject information “Project B”, task person information “Wang Wu”, and task time information “2022/10/28” are displayed.

The IM message 51 has also therein displayed a first control 511, and after the first control 511 is triggered by a user, a first page 60 can be displayed on a right side of the session interface 50, the first page 60 displaying a task ID “222” of the task “Project B”, task subject information “Project B”, task content information or remark information “XXX”, task person information “Wang Wu”, task time information “2022/10/28”, and task comment or description information “User A created the task 17:30”. The IM message 51 has also therein displayed a second control 512, and a second page (not shown in FIG. 6) may be displayed after the second control 512 is triggered by the user.

The recipient may modify all or part of the content of the task information displayed in the first page to update the task information. For example, referring to FIG. 6, the recipient may delete, add, etc. the task-associated person by triggering a first identification 61, or the recipient may modify the task time information by triggering a second identification 62, but this disclosure is not limited thereto.

Further, in some embodiments, an editing permission of the recipient may be limited, for example, it is only allowed that a recipient with a preset editing permission can edit the task information in the first page and/or the second page, to update the task information.

In some embodiments, the method 100 further comprises:
step S191: receiving a modification of the user on target task data of the already created task information in the online database table; and in response to a third preset operation of the user in the online database table, updating task information corresponding to the target task data on the basis of the modified target task data; and/or
step S192: in response to a fourth preset operation of the user in the online database table, making task information targeted by the fourth task operation in a deletion state.

Exemplarily, taking an online table as an example, it is possible to receive a modification of the user on a first record in the online table (for example, modifying one or more task data in the first record), and in response to a third preset operation of the user for the first record, update task information corresponding to the first record; and/or, in response to a fourth preset operation of the user for the first record, make a task corresponding to the first record in a deletion state; wherein the first record may be any record in the online table.

The third and fourth preset operations include, but are not limited to, a somatosensory control operation, a gesture control operation, an eyeball shaking operation, a touch control operation, a voice control instruction, or an operation on an external control device.

In some embodiments, the third preset operation of the user in the online database table comprises: inputting, by the user, preset third data under the first preset task field in the online database table; or, the fourth preset operation of the user in the online database table comprises: inputting, by the user, preset fourth data under the first preset task field in the online database table.

Exemplarily, referring to FIG. 3, the user may input preset third data (e.g., “Update task”) or fourth data (e.g., “Delete task”) under the first preset task field “Create/Cancel Task”, so that a corresponding task is updated or deleted. Further, referring to FIG. 3, one or more options (e.g., “Create task”, “Delete task”, “Update task”) may also be provided under the preset field “Create/Cancel Task” for selection by the user without manual input by the user. For example, the option “Create task” is used for triggering the function of creating a new task on the basis of the task data input by the user; the option “Delete task” is used for triggering the function of deleting an existing task corresponding to a record (e.g., row or column) where it is located; and the option “Update task” is used for triggering the function of updating an existing task on the basis of a current record.

It should be noted that the target task data may be any type of task data, or a specific type of task data (for example, task time, task person, etc.) for which modification is allowed after the task is created, which is not limited in this disclosure.

According to one or more embodiments of the present disclosure, not only a new task may be created on the basis of the online database table, but also an already created task may be updated or deleted on the basis of the online database table, so that the tasks may be managed more comprehensively on the basis of the online database table, further improving the task processing efficiency.

In some embodiments, preset content may also be displayed under a second preset task field on the basis of a creation state, updating state, deletion state, or sending state of the task information, wherein the preset content is used for indicating whether the state of the task information is successfully updated.

In some embodiments, after the user inputs the preset data under the first preset task field in the online database table, the content displayed under the second preset task field in the online database table is updated from first information to second information within a preset time. Exemplarily, the first information may be “not sync” or “in sync”, and the second information may be “successful sync” or “failed sync”, but this disclosure is not limited thereto. For example, referring to FIG. 4, after the user inputs “Create task” under the task field “Create/Cancel Task”, a 2nd row of record where the “Project B” is located may, at a corresponding position under the task field “Sync State”, be displayed as “in sync”; referring to FIG. 5, after the task “Project B” is successfully created or has been already sent to a related person, the 2nd row of record where the “Project B” is located may, at the corresponding position in the task field “Sync State”, be changed to “successful sync”. Similarly, after the user inputs “Update task” or “Delete task” under the task field “Create/Cancel Task”, the 2nd row of record where the “Project B” is located may, at the corresponding position under the task field “Sync State”, be display as “in sync”, and after the task information of the task “Project B” is successfully updated or deleted, “successful sync” is displayed.

In some embodiments, the online database table may be an online table, the task field may be a field of the online table, and a record of the online table is used for generating the task information. For example, in the online table, one record (e.g., a row or a column) may correspond to one task.

In some embodiments, the online table may be a multi-dimensional table by which the task information is managed. In some embodiments, a row or column in the multi-dimensional table is used for storing the task information. In some embodiments, the multi-dimensional table can record different types of data, including multimedia files such as pictures and videos, and in the multi-dimensional table, row or column storage may be used, task information of one task being stored in one row or column, for example, in FIG. 5, each row is used for storing task information of different tasks, respectively.

According to one or more embodiments of the present disclosure, the user can create, summarize, manage, and update a plurality of tasks through the online table, and the requirements of the user for creation, distribution and management of the tasks and task list visualization are simultaneously met using the online table, thereby improving the processing efficiency of the user for the tasks.

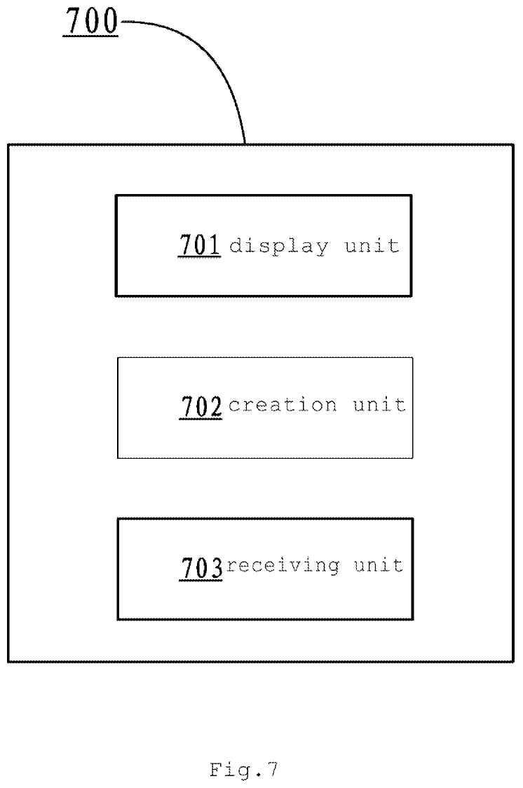

Accordingly, according to an embodiment of the present disclosure, there is provided an information processing apparatus 700, as shown in FIG. 7, comprising:
a display unit 701, configured to display an online database table, the online database table comprising at least one preset task field; a receiving unit 702, configured to receive task data corresponding to the task field, which is input by a user in the online database table;
a creation unit 703, configured to, in response to a first preset operation of the user in the online database table, create task information in a task application on the basis of the task data input by the user.

In some embodiments, the at least one preset task field comprises one or more of: a field for indicating a task title, a field for indicating a task ID, a field for indicating task content, a field for indicating a task-associated person, a field for indicating task time information, a field for indicating a task reminder manner, a field for indicating creating, cancelling or updating a task, a field for indicating a task completion state, and a field for indicating a task synchronization state.

In some embodiments, the information processing apparatus further comprises:
a person determination unit, configured to determine a task-associated person on the basis of the task data; and
an information sending unit, configured to send, to the task-associated person, the task information and/or reminder information of the task information.

In some embodiments, the information sending unit is configured to send, to the task-associated person, the task information and/or the reminder information of the task information by an IM (Instant Message) application associated with the online database table.

In some embodiments, the information sending unit is configured to send the task information and/or the reminder information of the task information in a form of an IM message by a message bot provided in the IM application.

In some embodiments, display content of the reminder information comprises one or more of: title information, task subject information, task person information, or task time information.

In some embodiments, the information processing apparatus further comprises:
a task detail display unit, configured to, in response to a second preset operation of a recipient of the reminder information for the reminder information, display task detail information.

In some embodiments, the task detail display unit is configured to, in response to a first operation of the recipient for the reminder information, display a first page, wherein the first page is used for presenting task information corresponding to the reminder information; and/or, in response to a second operation of the recipient for the reminder information, display a second page, wherein the second page is used for presenting task information associated with the recipient.

In some embodiments, the information processing apparatus further comprises:
a first updating unit, configured to, in response to an editing operation of the recipient on the task information in the first page or the second page, update the task information.

In some embodiments, a field of the online database table comprises the task field, and a record of the online database table are used for generating the task information.

In some embodiments, the information processing apparatus further comprises:
an update and deletion unit configured to receive a modification of the user on target task data of the already created task information in the online database table; in response to a third preset operation of the user in the online database table, update task information corresponding to the target task data on the basis of the modified target task data; and/or, in response to a fourth preset operation of the user in the online database table, making task information targeted by the fourth task operation in a deletion state.

In some embodiments, the first preset operation of the user in the online database table comprises: inputting, by the user, preset first data under a first preset task field in the online database table.

In some embodiments, the third preset operation of the user in the online database table comprises: inputting, by the user, preset third data under the first preset task field in the online database table; or, the fourth preset operation of the user in the online database table comprises: inputting, by the user, preset fourth data under the first preset task field in the online database table.

In some embodiments, the information processing apparatus further comprises:
a synchronization state unit configured to display preset content in a record corresponding to the task information under a second preset task field, on the basis of a creation state, an update state, a deletion state, or a sending state of the task information.

In some embodiments, after the user inputs the preset data under the first preset task field in the online database table, the content displayed under the second preset task field in the online database table is updated from first information to second information within a preset time. For the embodiments of the apparatus, reference can be made to the description of the method embodiments for related points, since they substantially correspond to the method embodiments. The apparatus embodiments described above are merely illustrative, in which modules illustrated as separate modules may or may not be separated. Some or all of the modules may be selected according to actual needs to realize the purpose of the solution of this embodiment. One of ordinary skill in the art can understand and implement them without paying creative labor.

Accordingly, according to one or more embodiments of the present disclosure, there is provided an electronic device, comprising:
at least one memory and at least one processor,
wherein, the memory is configured to store program code, and the processor is configured to call the program code stored by the memory, so that the electronic device performs the information processing method according to one or more embodiments of the present disclosure.

Accordingly, according to one or more embodiments of the present disclosure, there is provided a non-transitory computer storage medium having thereon stored program code which is executable by a computer device so that the computer device performs the information processing method according to one or more embodiments of the present disclosure.

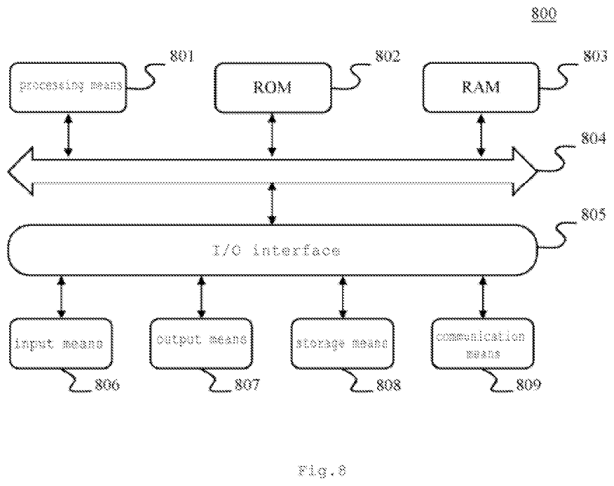

Referring to FIG. 8 hereinafter, it illustrates a schematic structural diagram of an electronic device (e.g., a terminal device or server) 800 suitable for implementing the embodiment of the present disclosure. The terminal device in the embodiment of the present disclosure may include, but is not limited to, a mobile terminal such as a mobile phone, a laptop, a digital broadcast receiver, a PDA (Personal Digital Assistant), a PAD (tablet), a PMP (Portable Multimedia Player), and a vehicle-mounted terminal (e.g., a vehicle-mounted navigation terminal), and a fixed terminal such as a digital TV, and a desktop computer. The electronic device shown in FIG. 8 is only an example, so that it should not bring any limitation to the functions and the scope of use of the embodiments of the present disclosure.

As shown in FIG. 8, the electronic device 800 may comprise a processing means (e.g., a central processing unit, graphics processing unit, etc.) 801, which may perform various appropriate actions and processes according to a program stored in a read-only memory (ROM) 802 or a program loaded from a storage means 808 into a random access memory (RAM) 803. In the RAM 803, various programs and data required for the operation of the electronic device 800 are also stored. The processing means 801, the ROM 802, and the RAM 803 are connected to each other by a bus 804. An input/output (I/O) interface 805 is also connected to the bus 804.

Generally, the following means may be connected to the I/O interface 805: an input means 806 including, for example, a touch screen, touch pad, keyboard, mouse, camera, microphone, accelerometer, gyroscope, etc. ; an output means 807 including, for example, a liquid crystal display (LCD), speaker, vibrator, etc. ; the storage means 808 including, for example, a magnetic tape, hard disk, etc. ; and a communication means 809. The communication means 809 may allow the electronic device 800 to communicate wirelessly or by wire with other devices to exchange data. While FIG. 8 illustrates the electronic device 800 having the various means, it should be understood that there is no requirement that all the illustrated means are implemented or provided. More or fewer means may be alternatively implemented or provided.

In particular, according to the embodiments of the present disclosure, the processes described above with reference to the flow diagrams may be implemented as a computer software program. For example, an embodiment of the present disclosure comprises a computer program product comprising a computer program carried on a computer-readable medium, the computer program comprising program code for performing the method illustrated by the flow diagrams. In such an embodiment, the computer program may be downloaded and installed from a network by the communication means 809, or installed from the storage means 808, or installed from the ROM 802. The computer program, when executed by the processing means 801, performs the above functions defined in the methods of the embodiments of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has one or more programs carried thereon, wherein the above one or more programs, when executed by the electronic device, cause the electronic device to perform the above method of the present disclosure.

Computer program code for performing the operation of the present disclosure may be written in one or more programming languages or a combination thereof, wherein the above programming language includes an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The name of the unit does not, in some cases, constitute a limitation on the unit itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, the machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, there is provided an information processing method, comprising: displaying an online database table, the online database table comprising at least one preset task field; receiving task data corresponding to the task field, which is input by a user in the online database table; and in response to a first preset operation of the user in the online database table, creating task information in a task application on the basis of the task data input by the user.

According to one or more embodiments of the present disclosure, the at least one preset task field comprises one or more of: a field for indicating a task title, a field for indicating a task ID, a field for indicating task content, a field for indicating a task-associated person, a field for indicating task time information, a field for indicating a task reminder manner, a field for indicating creating, cancelling, or updating a task, a field for indicating a task completion state, and a field for indicating a task synchronization state.

According to one or more embodiments of the present disclosure, a task-associated person is determined on the basis of the task data; and the task information and/or reminder information of the task information are/is sent to the task-associated person.

According to one or more embodiments of the present disclosure, the sending, to the task-associated person, the task information and/or reminder information of the task information, comprises: sending, to the task-associated person, the task information and/or the reminder information of the task information by an IM (Instant Message) application associated with the online database table.

According to one or more embodiments of the present disclosure, the sending, to the task-associated person, the task information and/or the reminder information of the task information by an IM (Instant Message) application associated with the online database table, comprises: sending the task information and/or the reminder information of the task information in a form of an IM message by a message bot provided in the IM application.

According to one or more embodiments of the present disclosure, display content of the reminder information comprises one or more of: title information, task subject information, task person information, or task time information.

According to one or more embodiments of the present disclosure, in response to a second preset operation of a recipient of the reminder information for the reminder information, task detail information is displayed.

According to one or more embodiments of the present disclosure, the displaying, in response to a second preset operation of a recipient of the reminder information for the reminder information, task detail information, comprises: in response to a first operation of the recipient for the reminder information, displaying a first page, wherein the first page is used for presenting task information corresponding to the reminder information; and/or, in response to a second operation of the recipient for the reminder information, displaying a second page, wherein the second page is used for presenting task information associated with the recipient.

According to one or more embodiments of the present disclosure, in response to an editing operation of the recipient on the task information in the first page or the second page, the task information is updated.

According to one or more embodiments of the present disclosure, a field of the online database table comprises the task field, and a record of the online database table is used for generating the task information.

According to one or more embodiments of the present disclosure, a modification of the user on target task data of the already created task information in the online database table is received; in response to a third preset operation of the user in the online database table, task information corresponding to the target task data is updated on the basis of the modified target task data; and/or in response to a fourth preset operation of the user in the online database table, task information targeted by the fourth task operation is made in a deletion state.

According to one or more embodiments of the present disclosure, the first preset operation of the user in the online database table comprises: inputting, by the user, preset first data under a first preset task field in the online database table.

According to one or more embodiments of the present disclosure, the third preset operation of the user in the online database table comprises: inputting, by the user, preset third data under the first preset task field in the online database table; or, the fourth preset operation of the user in the online database table comprises: inputting, by the user, preset fourth data under the first preset task field in the online database table.

According to one or more embodiments of the present disclosure, preset content is displayed in a record corresponding to the task information under a second preset task field on the basis of a creation state, an update state, a deletion state, or a sending state of the task information.

According to one or more embodiments of the present disclosure, after the user inputs the preset data under the first preset task field in the online database table, the content displayed under the second preset task field in the online database table is updated from first information to second information within a preset time.

According to one or more embodiments of the present disclosure, there is provided a computer program product which, when executed by a processor, implements the information processing method as described above.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

1. An information processing method, comprising:
displaying an online database table, the online database table comprising at least one preset task field;
receiving task data corresponding to the task field, which is input by a user in the online database table; and
in response to a first preset operation of the user in the online database table, creating task information in a task application on the basis of the task data input by the user.

2. The method according to claim 1, wherein the at least one preset task field comprises one or more of:
a field for indicating a task title, a field for indicating a task ID, a field for indicating task content, a field for indicating a task-associated person, a field for indicating task time information, a field for indicating a task reminder manner, a field for indicating creating, cancelling, or updating a task, a field for indicating a task completion state, or a field for indicating a task synchronization state.

3. The method according to claim 1, further comprising:
determining a task-associated person on the basis of the task data; and
sending, to the task-associated person, at least one of the task information or reminder information of the task information.

4. The method according to claim 3, wherein the sending, to the task-associated person, at least one of the task information or reminder information of the task information, comprises:
sending, to the task-associated person, at least one of the task information or the reminder information of the task information by an Instant Message IM application associated with the online database table.

5. The method according to claim 4, wherein the sending, to the task-associated person, at least one of the task information or the reminder information of the task information by an IM application associated with the online database table, comprises:
sending at least one of the task information or the reminder information of the task information in a form of an IM message by a message bot provided in the IM application.

6. The method according to claim 3, wherein display content of the reminder information comprises one or more of:
title information, task subject information, task person information, or task time information.

7. The method according to claim 3, further comprising:
in response to a second preset operation of a recipient of the reminder information for the reminder information, displaying task detail information.

8. The method according to claim 7, wherein the in response to a second preset operation of a recipient of the reminder information for the reminder information, displaying task detail information, comprises at least one of:
in response to a first operation of the recipient for the reminder information, displaying a first page, wherein the first page is used for presenting task information corresponding to the reminder information; or
in response to a second operation of the recipient for the reminder information, displaying a second page, wherein the second page is used for presenting task information associated with the recipient.

9. The method according to claim 8, further comprising:
in response to an editing operation of the recipient on the task information in the first page or the second page, updating the task information.

10. The method according to claim 1, wherein a field of the online database table comprises the task field, and a record of the online database table is used for generating the task information.

11. The method according to claim 1, further comprising at least one of:
receiving a modification of the user on target task data of the already created task information in the online database table; and in response to a third preset operation of the user in the online database table, updating task information corresponding to the target task data on the basis of the modified target task data;
or,
in response to a fourth preset operation of the user in the online database table, making task information targeted by the fourth task operation in a deletion state.

12. The method according to claim 1, wherein the first preset operation of the user in the online database table comprises:
inputting, by the user, preset first data under a first preset task field in the online database table.

13. The method according to claim 11, wherein
the third preset operation of the user in the online database table comprises: inputting, by the user, preset third data under the first preset task field in the online database table; or,
the fourth preset operation of the user in the online database table comprises: inputting, by the user, preset fourth data under the first preset task field in the online database table.

14. The method according to claim 1, further comprising:
displaying preset content in a record corresponding to the task information under a second preset task field, on the basis of a creation state, an update state, a deletion state, or a sending state of the task information.

15. The method according to claim 14, wherein after the user inputs the preset data under the first preset task field in the online database table, the content displayed under the second preset task field in the online database table is updated from first information to second information within a preset time.

16. (canceled)

17. An electronic device, comprising:
at least one memory and at least one processor,
wherein, the memory is configured to store program code, and the processor is configured to call the program code stored by the memory, so that the electronic device performs an information processing method, comprising:
displaying an online database table, the online database table comprising at least one preset task field;
receiving task data corresponding to the task field, which is input by a user in the online database table; and
in response to a first preset operation of the user in the online database table, creating task information in a task application on the basis of the task data input by the user.

18. A non-transitory computer storage medium, having thereon stored program code which, when executed by a computer device, causes the computer device to perform an information processing method, comprising:
displaying an online database table, the online database table comprising at least one preset task field;
receiving task data corresponding to the task field, which is input by a user in the online database table; and
in response to a first preset operation of the user in the online database table, creating task information in a task application on the basis of the task data input by the user.

19. (canceled)

20. The electronic device according to claim 17, wherein the at least one preset task field comprises one or more of:
a field for indicating a task title, a field for indicating a task ID, a field for indicating task content, a field for indicating a task-associated person, a field for indicating task time information, a field for indicating a task reminder manner, a field for indicating creating, cancelling, or updating a task, a field for indicating a task completion state, or a field for indicating a task synchronization state.

21. An electronic device, comprising:
at least one memory and at least one processor,
wherein, the memory is configured to store program code, and the processor is configured to call the program code stored by the memory, so that the electronic device performs the method according to claim 3.

22. A non-transitory computer storage medium, having thereon stored program code which, when executed by a computer device, causes the computer device to perform the method according to claim 2.
